(19) United States
(12) Patent Application Publication
(10) Pub. No.: US 2024/0361040 A1
(43) Pub. Date: Oct. 31, 2024

(54) POOL HEATER

(71) Applicant: DynoRaxx, Inc., Buffalo, NY (US)

(72) Inventor: Nathan T. Rizzo, Buffalo, NY (US)

(73) Assignee: DynoRaxx, Inc., Buffalo, NY (US)

(21) Appl. No.: 18/645,651

(22) Filed: Apr. 25, 2024

Related U.S. Application Data
(60) Provisional application No. 63/461,925, filed on Apr. 26, 2023.

(51) Int. Cl. F24S 10/17

(52) U.S. Cl. CPC F24S 10/17

(57) ABSTRACT

Pool heaters, including floating pool heaters, and related methods are presented. For instance, a pool heater includes a power supply; a body structure comprising a first portion comprising a heat absorbing material forming one or more channels; and a pump powered by the power supply to circulate a fluid via the one or more channels of the body structure. The heat absorbing material of the first portion absorbs solar energy and transfers the solar energy to the fluid circulating in the body structure of the pool heater and then to pool water.

### CROSS REFERENCE TO RELATED APPLICATIONS

This application claims priority to U.S. Provisional Patent Application Ser. No. 63/461,925, filed Apr. 26, 2023, the entirety of which is incorporated by reference herein.

### BACKGROUND

Conventional techniques for heating the water in swimming pools are limited to the concept of removing water from the swimming pool, heating the water outside of the swimming pool, and returning the water to the swimming pool. Typically, an external heater is connected to the circulation system of the pool and may be based on gas, electric or heat pump technologies. Due to rising energy costs, a need exists for enhanced methods for heating a swimming pool.

### BRIEF SUMMARY

In one embodiment a pool heater is presented. The pool heater includes a power supply; a body structure comprising a first portion comprising a heat absorbing material forming one or more channels; and a pump powered by the power supply to circulate a fluid via the one or more channels of the body structure. The heat absorbing material of the first portion absorbs solar energy and transfers the solar energy to the fluid circulating in the body structure of the pool heater and then to pool water.

In another embodiment a floating pool heater includes a power supply comprising a photovoltaic panel; a body structure comprising a first portion comprising a heat absorbing material forming one or more channels and supporting the power supply; and a pump powered by the power supply to circulate a fluid via the one or more channels of the body structure. The heat absorbing material of the first portion absorbs solar energy and transfers the solar energy to the fluid circulating in the body structure of the pool heater and then to pool water.

In a further embodiment, a method for heating a pool includes providing a floating pool heater in the pool; receiving solar energy via an upper portion of the floating pool heater; and conveying the solar energy to the pool water using a heat-transfer fluid.

An advantage realized in one or more embodiments described herein is that solar energy is used to heat the pool water from within the pool. Another advantage realized in one or more embodiments described herein is that the pool water may be heated independently from the circulation system of the pool. A further advantage realized in one or more embodiments described herein is that at least a portion of the pool is covered to reduce evaporative heat loss.

The above embodiments are exemplary only. Other embodiments as described herein are within the scope of the disclosed subject matter.

### BRIEF DESCRIPTION OF THE SEVERAL VIEWS OF THE DRAWINGS

So that the manner in which the features of the disclosure can be understood, a detailed description may be had by reference to certain embodiments, some of which are illustrated in the accompanying drawings. It is to be noted, however, that the drawings illustrate only certain embodiments and are therefore not to be considered limiting of its scope, for the scope of the disclosed subject matter encompasses other embodiments as well. The drawings are not necessarily to scale, emphasis generally being placed upon illustrating the features of certain embodiments. In the drawings, like numerals are used to indicate like parts throughout the various views, in which:

FIGS. 1A-1G illustrate embodiments of a pool heater in which pool water is heated and circulates within the pool heater, in accordance with one or more aspects set forth herein;

FIGS. 2A-2B illustrate embodiments of a pool heater in which a contained heat-transfer fluid circulates within the pool heater, in accordance with one or more aspects set forth herein; and

FIGS. 3A-2C illustrate embodiments of a pool heater, in accordance with one or more aspects set forth herein.

Corresponding reference characters indicate corresponding parts throughout several views. The examples set out herein illustrate several embodiments, but should not be construed as limiting in scope in any manner.

### DETAILED DESCRIPTION

The present disclosure relates to a pool heater that can easily be deployed for use in a swimming pool. Several different embodiments are set forth herein, and the disclosed features may be mixed and matched in order to achieve specific results. For example, some embodiments circulate pool water through a body structure of the heater in order to heat the pool, and other embodiments employ a closed loop system with a heat-transfer fluid and a radiator to distribute heat captured at or near the surface of the pool to the water inside the pool. In some embodiments, the fluid circulates using a pump that is powered by photovoltaic panels deployed on the pool heater. In other embodiments, fluid circulation may be achieved by connecting the pool heater to an already existing water circulation system of the pool. It is contemplated that within the scope of the invention, these various features may be combined to form different embodiments. By way of contrast, the prior art describes techniques in which heating of the pool water is achieved by removing a portion of the pool water from the pool and heating it externally. Disadvantageously, such techniques require extra connections between the pool heater and the pool.

The present disclosure further contemplates some self-contained embodiments in which the pool heater may be simply placed in the pool for use and removed when desired. For example, a consumer may deploy one or more pool heaters by simply placing floating them on the pool when desired. Of course, in such a case, the pool heaters may also be used multi-functionally, serving as a support float for items and people. In another example, a so-called kiddie pool or any pool may be combined with a pool heater of the present technique such that the pool heater substantially covers the surface of the pool. In such an example, the pool may be round, rectangular, oblong, or any other shape, and the pool heater may be shaped and sized to match the pool. In such a case, the pool heater would also serve as a cover for the pool, reducing heat loss of the pool.

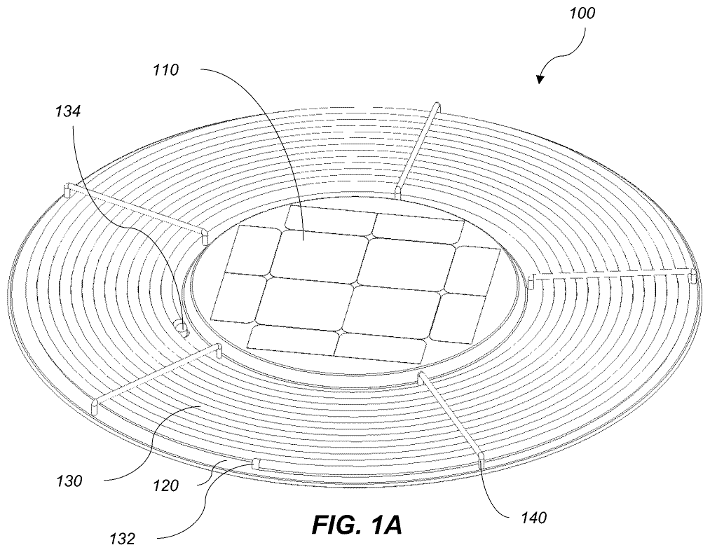

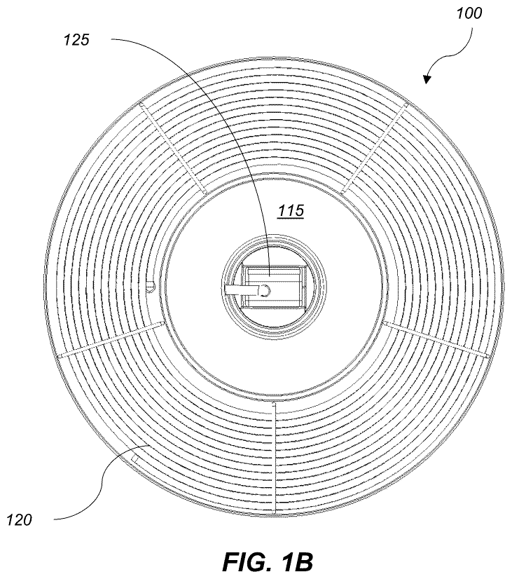

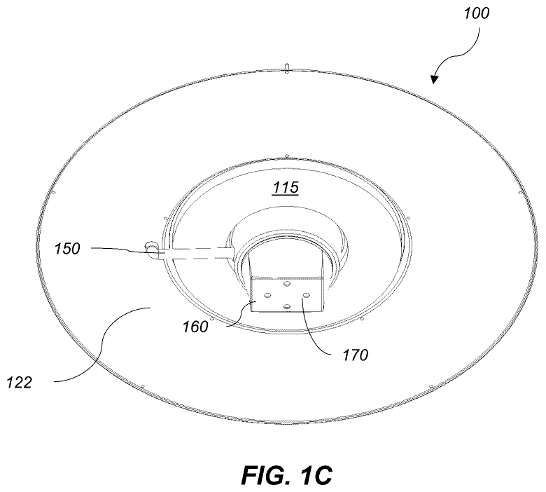

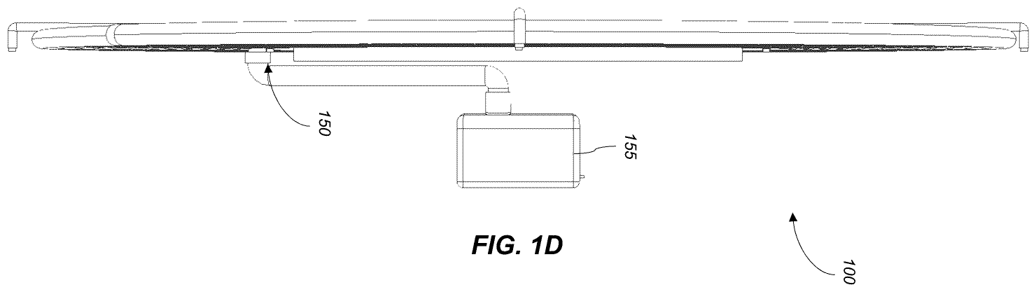

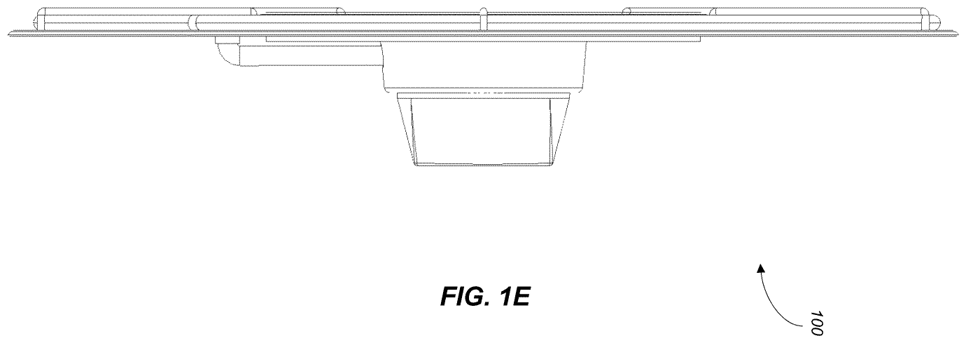

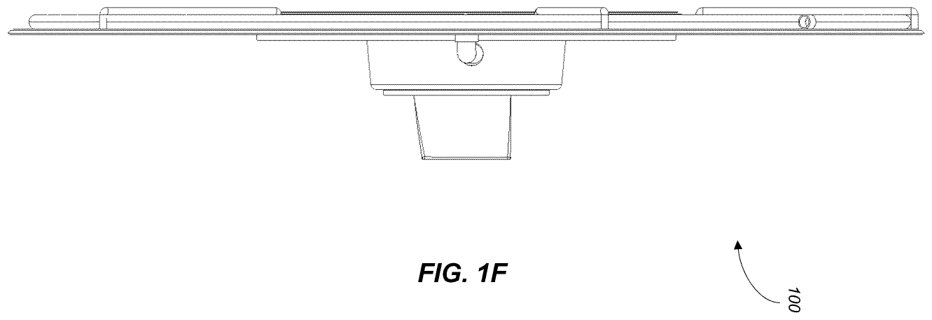

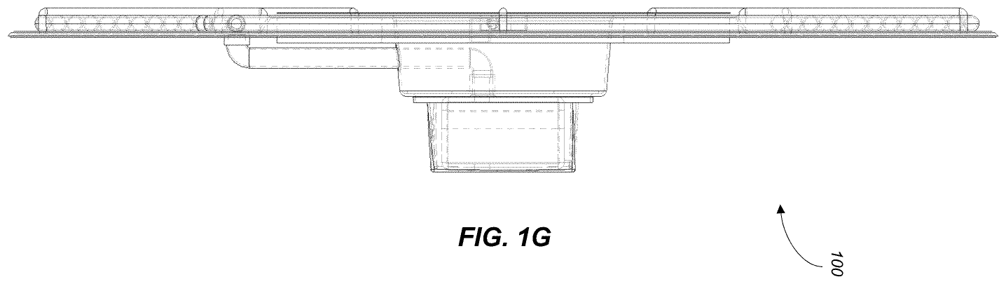

FIGS. 1A-1G illustrate embodiments of a pool heater 100 in which pool water is heated and circulates within the pool heater. For instance, in the embodiment of FIG. 1A, the pool heater 100 includes a power supply, such as a photovoltaic panel 110 and a body structure 120 for supporting the panel 110. In another example, the power supply may be an electrical power supply such as a battery pack. The body structure 120 may be made of a heat absorbing material, and can form one or more channels 130 in fluid communication with an inlet 132 and an outlet 134. Mechanical attachments 140 may be used to attach the body structure to a support structure 122 (FIG. 1C). Continuing, FIG. 1B depicts a pump 125 powered by the panel 110 to circulate water from the pool from the inlet 132 to the outlet 134 via the one or more channels 130. The channels 130 are made of a heat absorbing material which absorbs solar energy and transfers the solar energy to the water from the pool circulating therethrough. In another embodiment, a fluid line connects an outlet of the pool outlet to the inlet 132 so that a pump may not be needed for circulation. In one example, the pump 125 may be a submersible water pump, for example a brushless DC motor water pump, such as those known in the art.

In one implementation the body structure 120, the channels 130, the inlet 132 and the outlet 134 comprise a unitary structure molded from a polymer material. In another implementation, the one or more channels 130 are configured as a spiral channel. For instance, the body structure 120 may be made of polyethylene or any other suitable material, and may be dark colored to help absorb thermal energy.

In another embodiment, the pool heater 100 further includes an anchor designed to anchor the pool heater to a specific area of the pool so as to keep the pool heater in the sun to receive solar heat energy.

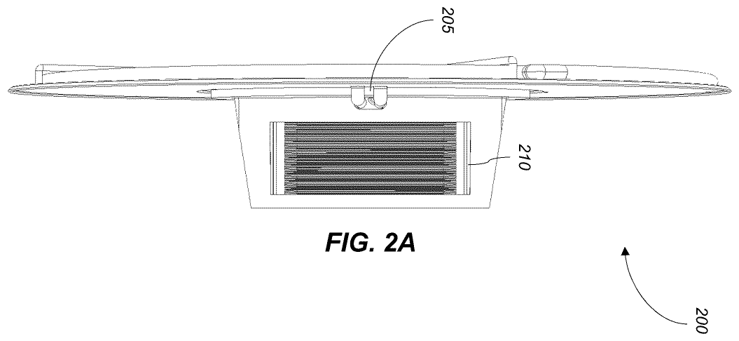

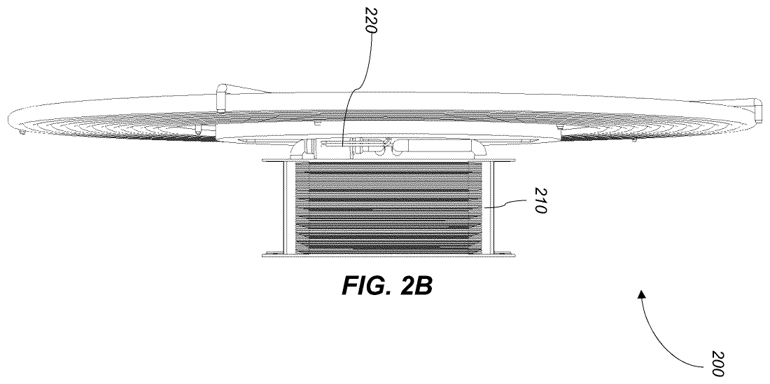

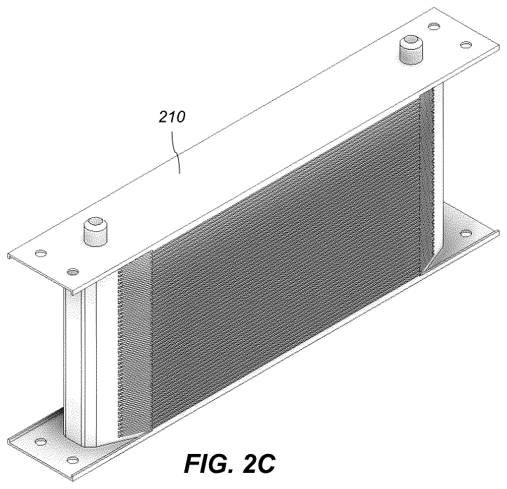

FIGS. 2A-2C are related to the prior disclosed embodiments, and illustrate embodiments of a pool heater 200 in which a contained heat-transfer fluid circulates within the pool heater 200. By contrast with the pool water circulating embodiments described above, the embodiment of FIGS. 2A-2C includes a sealed architecture in which the heat-transfer fluid may be used to bring heat from the sun down into the pool. For instance, now the channels 130 are connected to form a closed loop through a radiator 210 and an inline pump 220. The coils may be filled with a heat transfer fluid, such propylene glycol or the like. In another example, water may be used as the heat-transfer fluid. The radiator 210 ensures that captured heat is dissipated into the pool water. In one example, the pump 220 may be an inline pump that is relatively lower in capacity and energy requirements than the pump 125. In one example, the radiator 210 may be a transmission oil cooler radiator, such as a 16 row, 330 mm by 122 mm aluminum alloy radiator, or any other suitable radiator, such as those known in the art. In another example, the radiator may simply be a continuation of the channels 130 now underneath the pool heater 200 and in more direct Many different variations are within the scope of the present disclosure. For instance, the radiator may be oriented vertically or horizontally, extra tubing may be used to offset the radiator deeper into the pool water, or an additional pump may be used to circulate pool water around the radiator. The radiator may be surrounded by a protective shroud or housing, made of a suitable polymer material such as polyethylene. In such a case, the radiator may itself be simply an extension of the polymer tubing or structure that is located below the top of the pool heater and extending downwards into the water, e.g., coiled tubing located underwater. Any of the pool heaters may be outfitted with a manual off switch or may sense that the pool heater is no longer in the water and shutoff. Such a shutoff may be accomplished by either a pump sensing the lack of water (in the open loop system) or a water sensor in either device so that it is ceases operation when removed from the pool. Other variations include battery power or external power adapters for the pump.

Although some embodiments are described as floating pool heaters, it is important to note that these devices may be used from outside the pool. For example, the pool heater may be set away from the pool so that the pool may be used. In such a case, the heat-transfer portions may be extended such that the circulation continues although the pool heater is not floating inside the pool. For example, this may be achieved for either the closed-loop embodiments or the heated pool water embodiments. In addition, if the pool has a circulation pump, other embodiments of the present technique can make use of the circulation pump. For example, an inlet of a pool heater as described herein may be connected to a return of the pool, such that the circulation occurs without the need for a power supply or a pump on the pool heater.

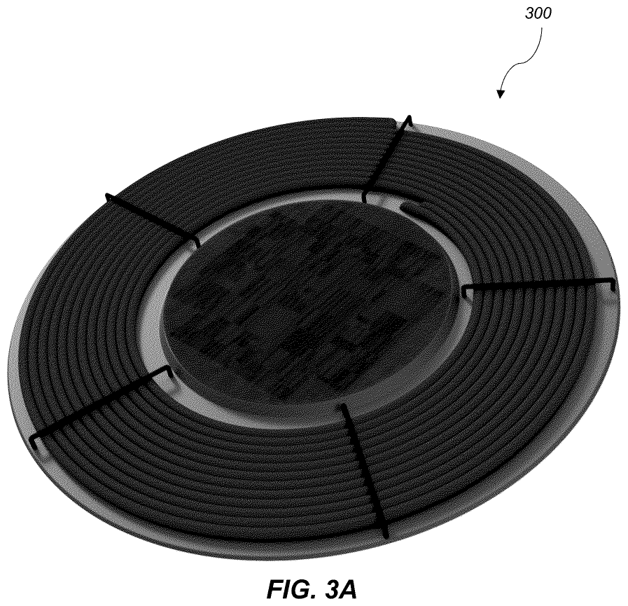

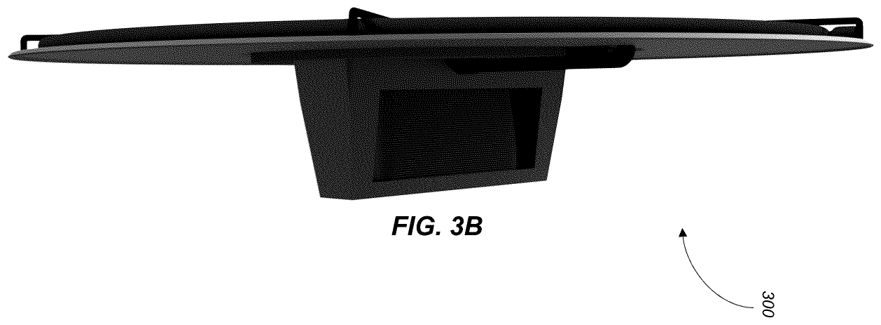

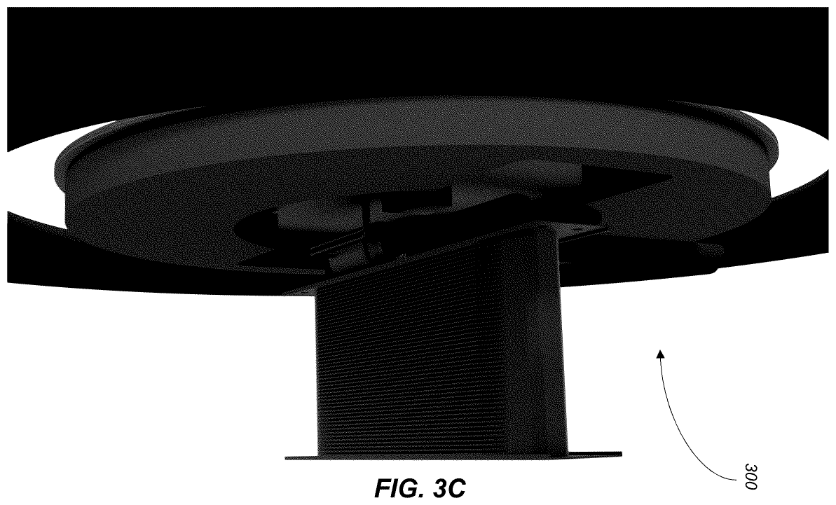

FIGS. 3A-2C illustrate embodiments of a pool heater 300, showing various possible sizes and shapes of the apparatus.

What is claimed is:

1. A pool heater for heating a pool, the pool heater comprising:
a power supply;
a body structure comprising a first portion comprising a heat absorbing material forming one or more channels;
a pump powered by the power supply to circulate a fluid via the one or more channels of the body structure; and
wherein the heat absorbing material of the first portion absorbs solar energy and transfers the solar energy to the fluid circulating in the body structure of the pool heater and then to pool water.

2. The pool heater of claim 1, wherein the power supply is powered by the solar energy.

3. The pool heater of claim 1, wherein the power supply comprises a photovoltaic panel, the photovoltaic panel being supported by the body structure.

4. The pool heater of claim 1, wherein the channels are in fluid communication with an inlet and an outlet, and the fluid circulating in the body structure comprises pool water.

5. The pool heater of claim 1, wherein the channels comprise a closed loop and the fluid circulating in the body structure comprises a heat-transfer fluid.

6. The pool heater of claim 1, further comprising a heat-transfer device for transferring heat from the heat-transfer fluid into the pool water.

7. The pool heater of claim 6, wherein the heat-transfer device comprises coils of the body structure located in contact with the pool water.

8. The pool heater of claim 6, wherein the heat-transfer device comprises a radiator or heat-sink located in contact with the pool water.

9. The pool heater of claim 1, wherein the pool heater is floated on a pool.

10. The pool heater of claim 1, wherein the pool heater is disposed outside of a pool.

11. A method for heating a pool, the method comprising:
providing a floating pool heater in the pool;
receiving solar energy via an upper portion of the floating pool heater; and
conveying the solar energy to the pool water using a heat-transfer fluid.

12. The method of claim 11, further comprising generating electrical energy using the solar energy, wherein the conveying comprises using the electrical energy to pump the heat-transfer fluid.

13. The method of claim 11, wherein the heat-transfer fluid is one of water or another heat-transfer fluid, and the conveying comprises circulating in a closed-loop the heat transfer fluid.

14. The method of claim 11, wherein the heat-transfer fluid is pool water and the conveying comprises circulating the pool water from an inlet of the pool heater to an outlet of the pool heater.

15. A floating pool heater for heating a pool, the floating pool heater comprising:
a power supply comprising a photovoltaic panel;
a body structure comprising a first portion comprising a heat absorbing material forming one or more channels and supporting the power supply;
a pump powered by the power supply to circulate a fluid via the one or more channels of the body structure; and
wherein the heat absorbing material of the first portion absorbs solar energy and transfers the solar energy to the fluid circulating in the body structure of the pool heater and then to pool water.

16. The floating pool heater of claim 15, wherein the channels are in fluid communication with an inlet and an outlet, and the fluid circulating in the body structure comprises pool water.

17. The floating pool heater of claim 15, wherein the channels comprise a closed loop and the fluid circulating in the body structure comprises a heat-transfer fluid.

18. The floating pool heater of claim 15, further comprising a heat-transfer device for transferring heat from the heat-transfer fluid into the pool water.

19. The floating pool heater of claim 18, wherein the heat-transfer device comprises coils of the body structure located in contact with the pool water.

20. The floating pool heater of claim 18, wherein the heat-transfer device comprises a radiator or heat-sink located in contact with the pool water.
